(19) United States
(12) Patent Application Publication
(10) Pub. No.: US 2012/0169905 A1
(43) Pub. Date: Jul. 5, 2012

(54) Method And Image Sensor For Image Sharpening And Apparatuses Including The Image Sensor

(75) Inventors: Ilia Ovsiannikov, Studio City, CA (US); Dong Ki Min, Seoul (KR)

(73) Assignee: SAMSUNG ELECTRONICS CO., LTD., Suwon-si (KR)

(21) Appl. No.: 13/297,794

(22) Filed: Nov. 16, 2011

(30) Foreign Application Priority Data
Jan. 3, 2011 (KR) 10-2011-0000129

(51) Int. Cl. G06K 9/40; H04N 5/208; G06K 9/00

(52) U.S. Cl. 348/252; 382/266; 382/172; 348/E05.024

(57) ABSTRACT

The method includes deciding a predominant edge direction of an image using edge directions of a plurality of pixels, and sharpening each of the pixels based on the predominant edge direction and the edge directions of the pixels.

### CROSS-REFERENCE TO RELATED APPLICATIONS

This application claims priority under 35 U.S.C. §119 to the benefit of Korean

Patent Application No. 10-2011-0000129, filed on Jan. 3, 2011, in the Korean Intellectual Property Office, the entire disclosure of which is incorporated herein by reference.

### BACKGROUND

Some embodiments of the present inventive concepts relate to an image sharpening method. At least one embodiment relates to a method and/or image sensor for sharpening an image without increasing image noise. At least one embodiment relates to apparatuses including the image sensor.

The reduction of a pixel size in image sensors leads to the decrease in cost and size of image sensing systems. Accordingly, it is desirable to design and manufacture image sensors having a smaller pixel size. However, the smaller pixel size is usually vulnerable to noise and leads to blurry images. Image sharpening is applied to captured images to counteract the blur. Conventional image sharpening methods usually increase image noise.

### SUMMARY

Some embodiments provide a method and/or image sensor for sharpening an image without increasing image noise and apparatuses including the image sensor.

According to some embodiments, there is provided a method for image sharpening. The method includes the operations of deciding a predominant edge direction of an image based on edge directions of a plurality of pixels and sharpening each of the pixels based on the predominant edge direction and the edge directions of the pixels.

The operation of deciding the predominant edge direction of the image may include calculating an edge direction and an edge amplitude of each of the pixels, creating a histogram by integrating the edge directions of the pixels, and setting an edge direction occurring with a greatest frequency in the histogram as the predominant edge direction.

The operation of calculating the edge direction and the edge amplitude of each of the pixels may include calculating a horizontal edge strength component and a vertical edge strength component using a pixel signal of a selected one of the pixels and pixel signals of neighbor pixels neighboring the selected pixel, calculating the edge direction using the horizontal edge strength component and the vertical edge strength component, and calculating the edge amplitude using a difference between a pixel signal of the selected pixel and a pixel signal of one of the neighbor pixels.

The edge direction may have a value ranging from 0 to 45 degrees.

The operation of creating the histogram may include excluding an edge direction corresponding to a value of an edge amplitude which is less than a threshold value.

The operation of sharpening the pixels may include generating a sharpening attenuation lookup table using the predominant edge direction and the edge directions of the pixels, calculating an amount of sharpening using the sharpening attenuation lookup table, and sharpening each of the pixels using the amount of sharpening.

According to another embodiment, the method includes determining a horizontal edge strength based on a pixel signal of a target pixel and pixel signals of a first set of neighboring pixels neighboring the target pixel, determining a vertical edge strength based on the pixel signal of the target pixel and pixel signals of a second set of neighboring pixels neighboring the target pixel, determining a direction of an edge associated with the target pixel based on the horizontal edge strength and the vertical edge strength, performing the determining operations for a plurality of target pixels to obtain a plurality of associated edge directions, determining a predominant edge direction based on the plurality of associated edge directions; and sharpening a portion of the image based on the predominant edge direction and the plurality of associated edge directions.

According to another embodiment, there is provided an image sensor including an image sensing block configured to convert an optical image into electrical image data and output the electrical image data; and an image signal processor configured to decide a predominant edge direction of the electrical image data using edge directions of a plurality of pixels forming the electrical image data and to sharpen each of the pixels based on the predominant edge direction and the edge directions of the pixels.

According to a further embodiment, there is provided an image sensing system including an image sensor configured to convert an optical image into electrical image data and output the electrical image data; and an image signal processor configured to decide a predominant edge direction of the electrical image data using edge directions of a plurality of pixels forming the electrical image data and to sharpen each of the pixels based on the predominant edge direction and the edge directions of the pixels.

### BRIEF DESCRIPTION OF THE DRAWINGS

The above and other features and advantages of the embodiments will become more apparent by describing in detail exemplary embodiments thereof with reference to the attached drawings in which:

FIG. 1 is a schematic block diagram of an image sensing system according to an example embodiment;

FIG. 2 is a plan view of a 5×5 kernel for calculating an edge direction according to an example embodiment;

FIG. 3A shows an image including an edge occurring at the border between a region A and a region B;

FIG. 3B shows an image including an edge occurring at the border between a region C and a region D;

FIG. 3C shows an image including an edge occurring at the border between a region E and a region F;

FIG. 4 shows weights used to calculate a horizontal edge strength component when the 5×5 kernel illustrated in FIG. 2 is positioned at a green pixel;

FIG. 5 shows weights used to calculate a horizontal edge strength component when the 5×5 kernel illustrated in FIG. 2 is positioned at a red pixel;

FIG. 6 shows weights used to calculate a vertical edge strength component when the 5×5 kernel illustrated in FIG. 2 is positioned at a green pixel;

FIG. 7 shows weights used to calculate a vertical edge strength component when the 5×5 kernel illustrated in FIG. 2 is positioned at a red pixel;

FIG. 8 shows a test chart image in which a predominant edge direction is 45 degrees:

FIG. 9 is a histogram of the test charge image illustrated in FIG. 8;

FIG. 10 shows a test chart image in which a predominant edge direction is horizontal;

FIG. 11 is a histogram of the test charge image illustrated in FIG. 10;

FIG. 12 shows a natural scene image;

FIG. 13 is a histogram of the natural scene image illustrated in FIG. 12;

FIG. 14 shows an urban scene image;

FIG. 15 is a histogram of the urban scene image illustrated in FIG. 14;

FIG. 16A shows a test chart image that has been sharpened using a conventional image sharpening method;

FIG. 16B shows a test chart image that has been sharpened using an image sharpening method according to an example embodiment;

FIG. 17A is a graph showing the luminance noise of the image illustrated in FIG. 16A;

FIG. 17B is a graph showing the luminance noise of the image illustrated in FIG. 16B;

FIG. 18A shows a natural scene image that has been sharpened using the conventional image sharpening method;

FIG. 18B shows a natural scene image that has been sharpened using the image sharpening method according to an example embodiment;

FIG. 18C shows a natural scene image that has not been subjected to image sharpening;

FIG. 19A shows an urban scene image that has been sharpened using the conventional image sharpening method;

FIG. 19B shows an urban scene image that has been sharpened using the image sharpening method according to an example embodiment;

FIG. 19C shows an urban scene image that has not been subjected to image sharpening;

FIG. 20 is a flowchart of an image sharpening method for an image sensing system according to an example embodiment; and

FIG. 21 is a schematic block diagram of an image sensing system according to an example embodiment.

### DETAILED DESCRIPTION OF THE EMBODIMENTS

Example embodiments now will be described more fully hereinafter with reference to the accompanying drawings, in which embodiments are shown. The example embodiment may, however, be embodied in many different forms and should not be construed as limited to those set forth herein. Rather; these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific term's) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

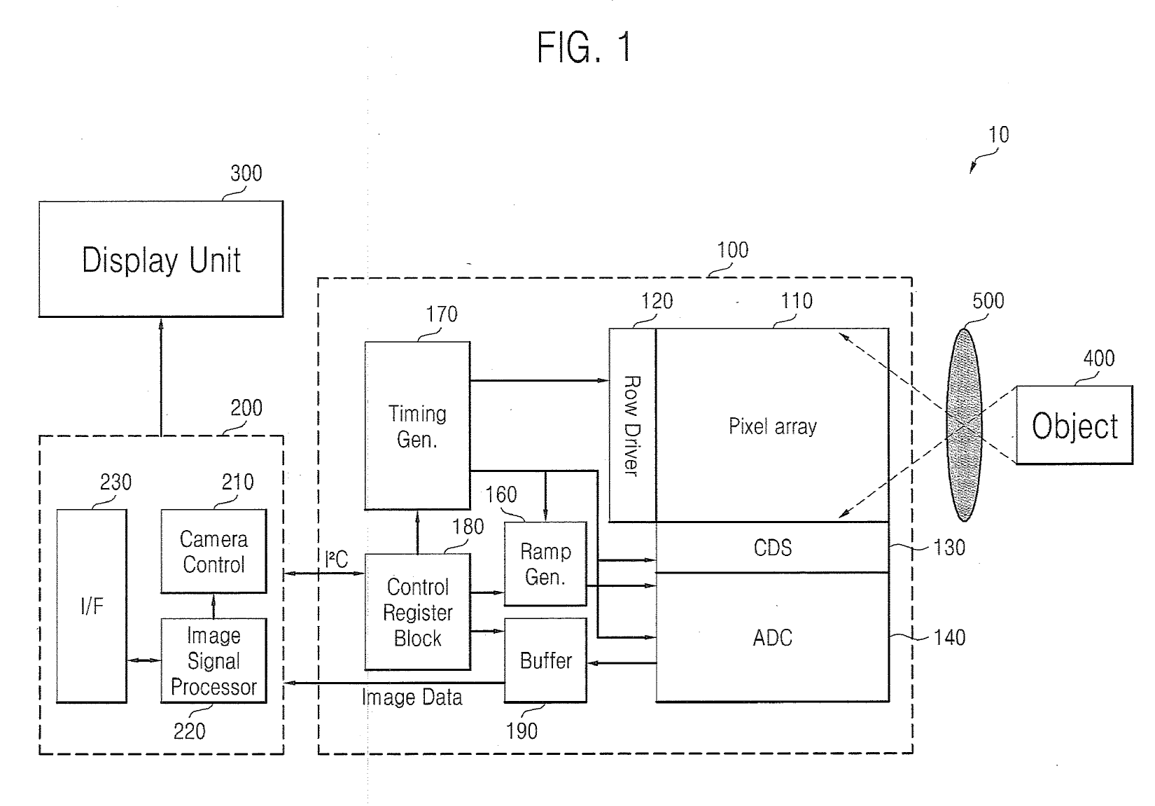

FIG. 1 is a schematic block diagram of an image sensing system 10 according to an example embodiment. Referring to FIG. 1, the image sensing system 10 includes an image sensor 100, a digital signal processor (DSP) 200, and a display unit 300.

The image sensor 100 includes a pixel array or an active pixel sensor (APS) array 110, a row driver 120, a correlated double sampling (CDS) block 130, an analog-to-digital converter (ADC) 140, a ramp generator 160, a timing generator 170, a control register block 180, and a buffer 190.

The image sensor 100 is controlled by the DSP 200 to sense an object 400 photographed through a lens 500 and output electrical image data. In other words, the image sensor 100 converts a sensed optical image into electrical image data and outputs the electrical image data.

The pixel array 110 includes a plurality of photo sensitive devices such as photo diodes or pinned photo diodes. The pixel array 110 senses light using the photo sensitive devices and converts the light into an electrical signal to generate an image signal.

The timing generator 170 may output a control signal to the row driver 120, the ADC 140, and the ramp generator 160 to control the operations of the row driver 120, the

ADC 140, and the ramp generator 160. The control register block 180 may output a control signal to the ramp generator 160, the timing generator 170, and the buffer 190 to control the operations of the elements 160, 170, and 190. The control register block 180 is controlled by a camera control 210.

The row driver 120 drives the pixel array 110 in units of rows. For instance, the row driver 120 may generate a row selection signal. The pixel array 110 outputs to the CDS block 130 a reset signal and an image signal from a row selected by the row selection signal provided from the row driver 120. The CDS block 130 may perform CDS on the reset signal and the image signal.

The ADC 140 compares a ramp signal output from the ramp generator 160 with a

CDS signal output from the CDS block 130, generates a comparison signal, counts duration time of a desired (or, alternatively a predetermined) level, e.g., a high level or a low level, of the comparison signal, and outputs a count result to the buffer 190.

The buffer 190 temporarily stores a digital signal output from the ADC 130 and senses and amplifies the digital signal before outputting the digital signal. The buffer 190 may include a plurality of column memory blocks, e.g., static random access memories (SRAMs), provided for respective columns for temporal storing; and a sense amplifier sensing and amplifying the digital signal output from the ADC 130.

The DSP 200 may output image data, which has been sensed and output by the image sensor 100, to the display unit 300. At this time, the display unit 300 may be any device that can output an image. For instance, the display unit 300 may be a computer, a mobile phone, or any type of image display terminal. The DSP 200 includes the camera control 210, an image signal processor 220, and a personal computer (PC) interface (I/F) 230. The camera control 210 controls the control register block 180. The camera control 210 may control the image sensor 100 according to the I2C protocol.

The image signal processor 220 receives image data, i.e., an output signal of the buffer 190, performs a processing operation on an image corresponding to the image data, and outputs the image to the display unit 300 through PC I/F 230. The processing operation may be or include image sharpening.

The image signal processor 220 determines a predominant edge direction of the electrical image data using an edge direction of each of a plurality of pixels forming the electrical image data, and sharpens each of the pixels according to the predominant edge direction and the edge direction of each pixel.

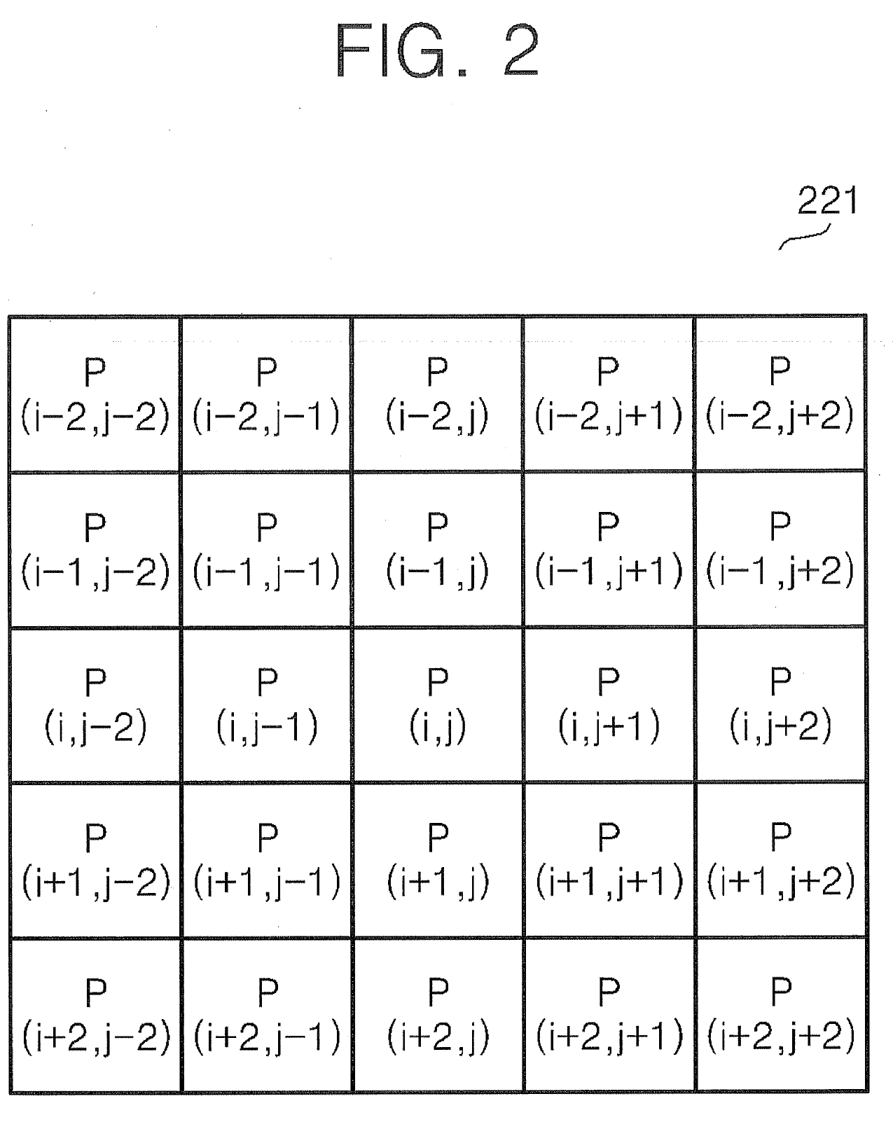

FIG. 2 is a plan view of a 5×5 kernel or mask 221 for calculating an edge direction according to an example embodiment. Referring to FIGS. 1 and 2, when the image sensing system 10 is implemented as a mobile phone, it has area and power constraints. The amount of sharpening is calculated using several lines. For purpose of description only, it is assumed that the image signal processor 220 performs image sharpening using the 5×5 kernel 221. The amount of sharpening may vary with embodiments.

The 5×5 kernel 221 illustrated in FIG. 2 is a sub-window or mask which moves over an image in a line-scanning fashion. When the 5×5 kernel 221 moves, the sharpening of each pixel is calculated. In other words, the edge direction of each pixel is calculated. The 5×5 kernel 221 includes a plurality of pixels P(i−2,j−2), P(i,j), P(i+2,j+2).

An edge is a significant local change of intensity. The edge usually occurs at the border between two different regions in an image.

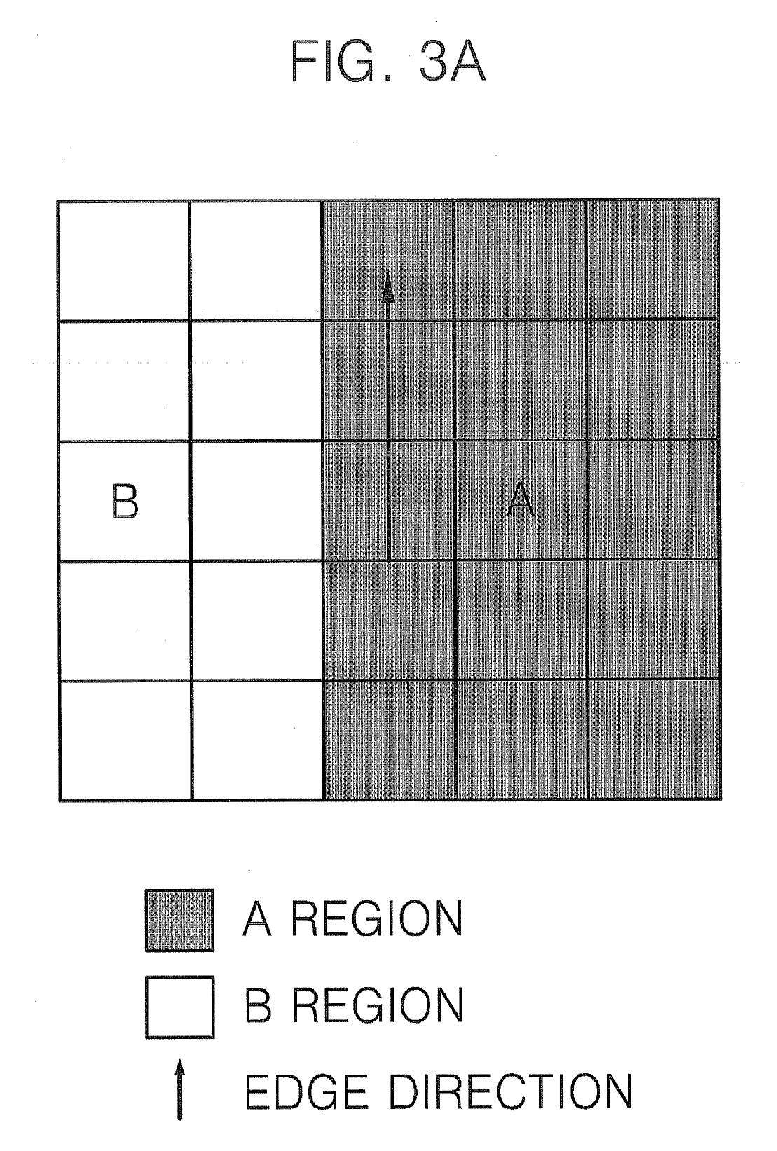

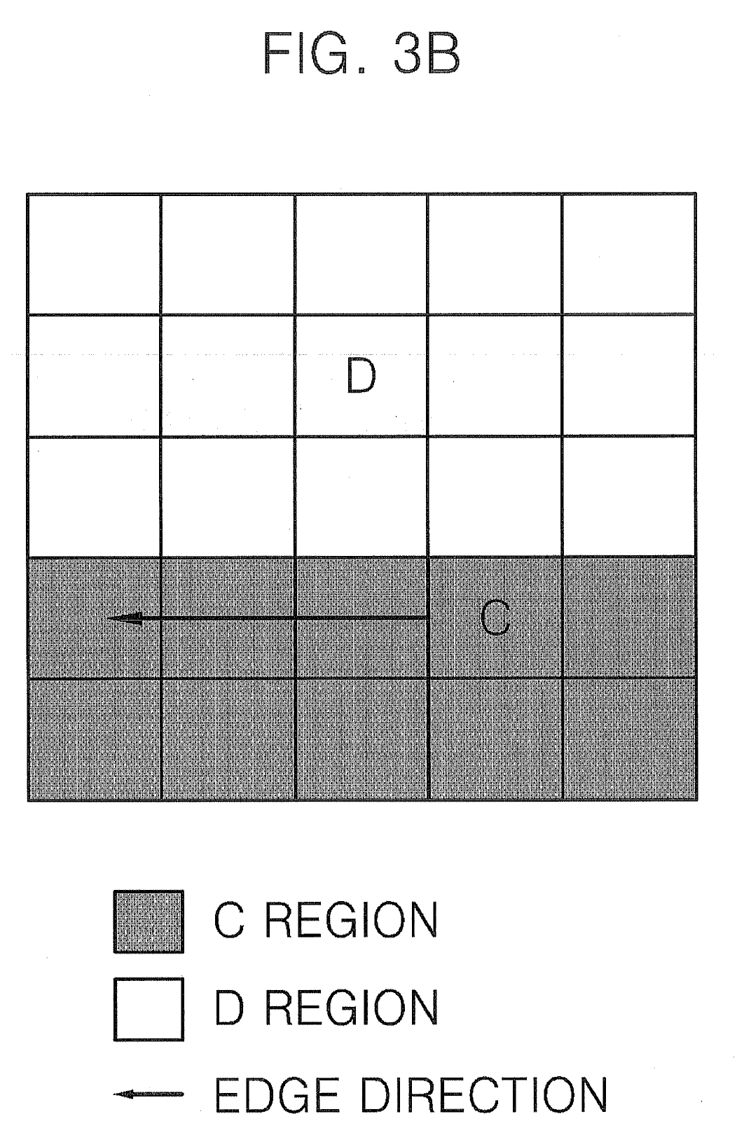

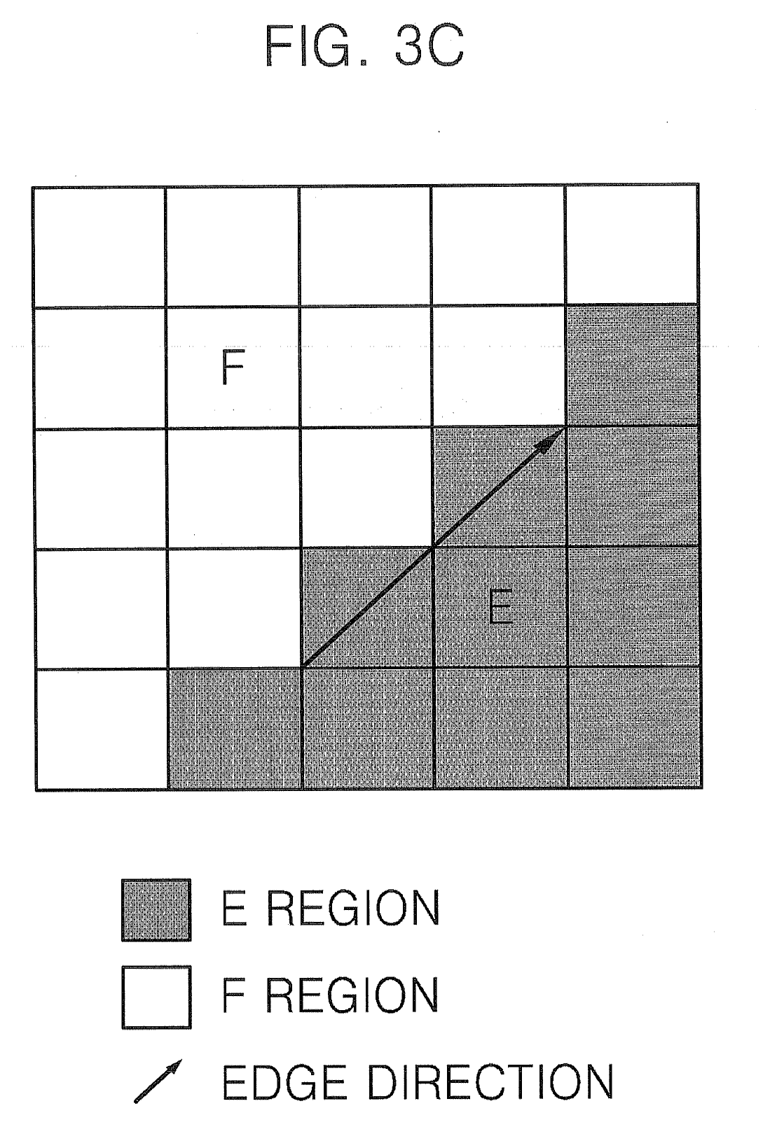

For instance, FIG. 3A shows an image including an edge occurring at the border between region A and region B. The direction of the edge in the image is vertical. FIG. 3B shows an image including an edge occurring at the border between region C and region D. The direction of the edge in the image is horizontal. FIG. 3C shows an image including an edge occurring at the border between region E and region F. The direction of the edge in the image is diagonal at an angle of 45 degrees.

Referring to FIGS. 1 and 2, the image signal processor 220 calculates the edge direction and the edge amplitude of the plurality of pixels P(i,j). The position of a pixel P(i,j) changes in an image every time when the 5×5 kernel 221 moves. Accordingly, whenever the 5×5 kernel 221 moves, the edge direction, i.e., T(i,j), and the edge amplitude of the pixel P(i,j) change. The edge amplitude is a signal difference between two pixels respectively belonging to two different regions. For example, the edge amplitude is calculated using the difference between the first pixel signal P(i,j) and the second pixel signal P(i,j−1). The edge direction T(i,j) is calculated using Equation 1:

T(i,j)=min(|H(i,j)|,|V(i,j)|)/max(|H(i,j)|,|V(i,j)|) (1)

where |H(i,j)| is an absolute value of a horizontal edge strength component, |V(i,j)| is an absolute value of a vertical edge strength component, “min” is a function of selecting the smaller one between two parameters, and “max” is a function of selecting the greater one between the two parameters.

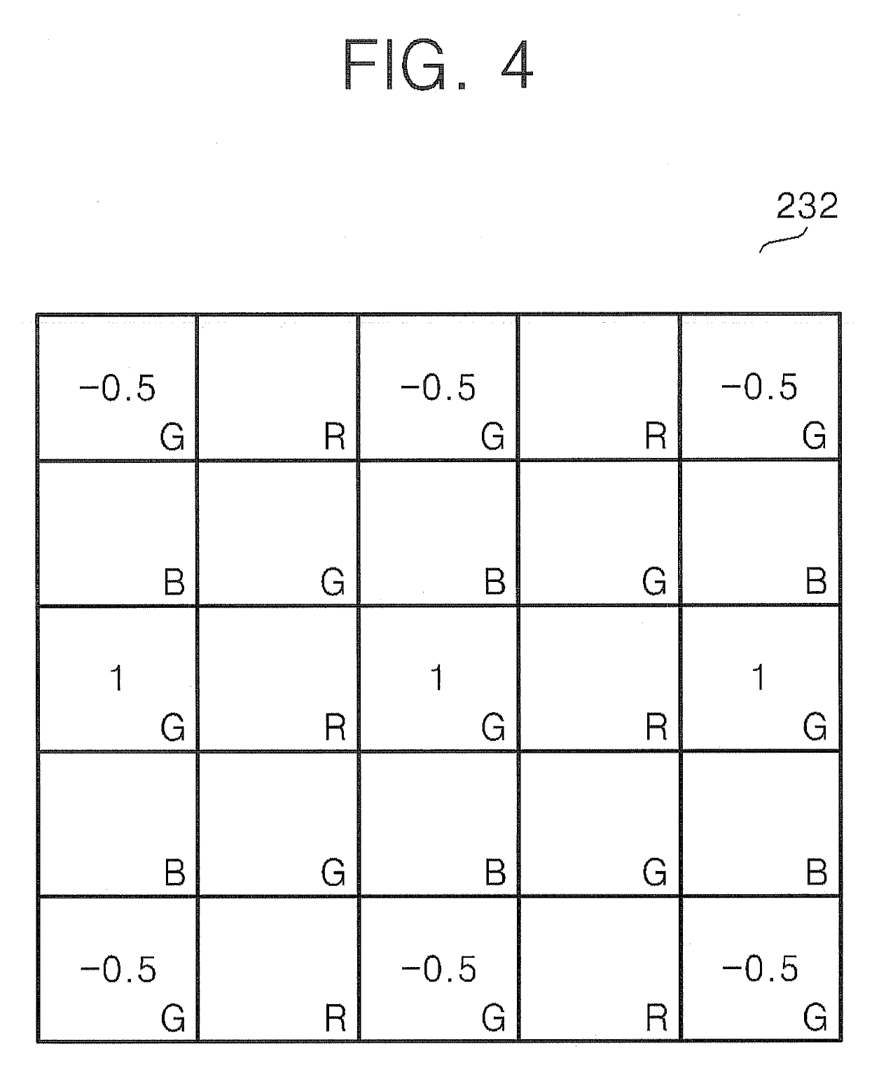

FIG. 4 shows weights used to calculate a horizontal edge strength component when the 5×5 kernel 221 illustrated in FIG. 2 is positioned at a green pixel. “R” denotes a red pixel, “G” denotes a green pixel, and “B” denotes a blue pixel. Referring to FIGS. 1 through 4, the pixels P(i−2,j−2), P(i−2,j), P(i−2,j+2), P(i+2,j−2), P(i+2,j), and P(i+2,j+2) have a weight of −0.5 and the pixels P(i,j−2), P(i,j), and P(i,j+2) have a weight of 1.

When a 5×5 kernel 232 is positioned at a green pixel G, that is, when the pixel P(i,j) is a green pixel G, the horizontal edge strength component H(i,j) is calculated using Equation 2:

H(i,j)=(P(i,j−2)+P(i,j)+P(i,j+2))−0.5*(P(i−2,j−2)+P(i−2,j)+P(i+2,j−2)+P(i+2,j)+P(i+2,j+2)) (2)

where P(i,j−2), P(i,j), P(i+2,j+2) each indicates a value of each pixel signal.

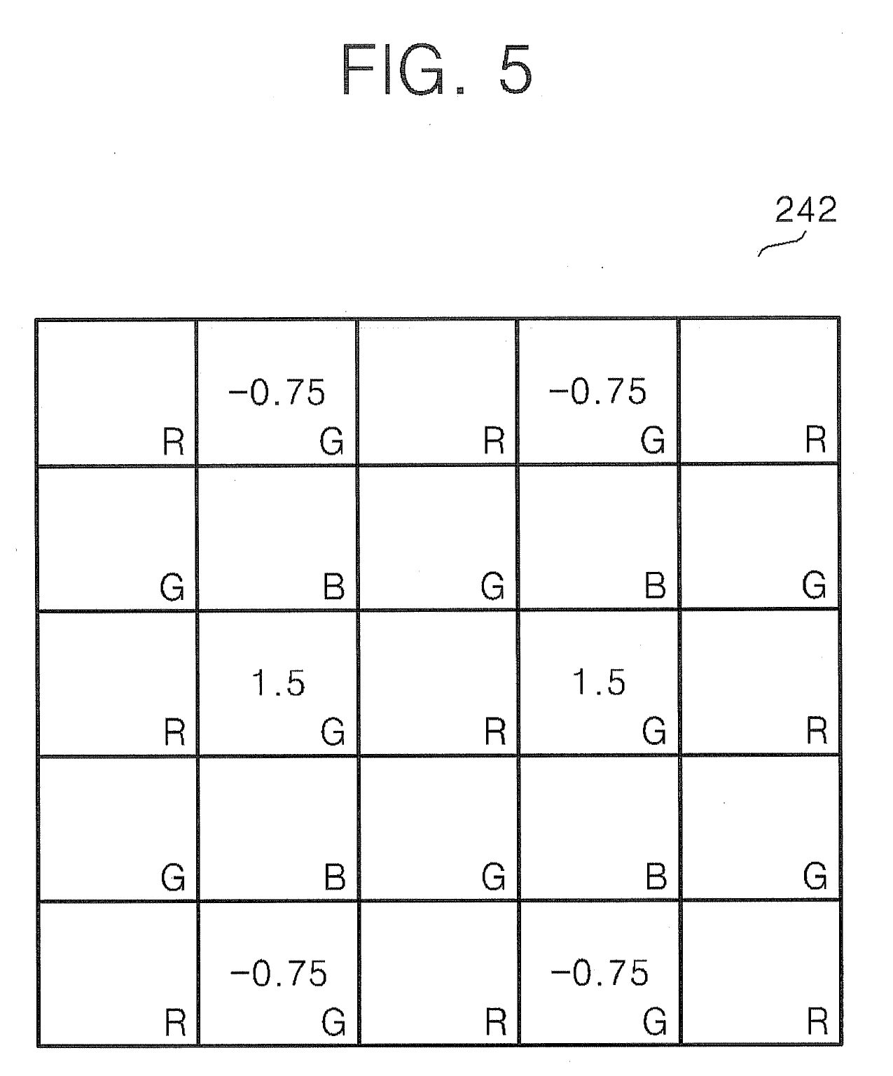

FIG. 5 shows weights used to calculate a horizontal edge strength component H(i,j) when the 5×5 kernel 221 illustrated in FIG. 2 is positioned at a red pixel R. Referring to FIGS. 1 through 5, the pixels P(i−2,j−1), P(i−2,j+1), P(i+2,j−1), and P(i+2,j+1) have a weight of −0.75 and the pixels P(i,j−1) and P(i,j+1) have a weight of 1.5. When a 5×5 kernel 242 is positioned at a red pixel R, that is, when the pixel P(i,j) is a red pixel R, the horizontal edge strength component H(i,j) is calculated using Equation 3:

H(i,j)=1.5*(P(i,j−1)+P(i,j+1))−0.75*(P(i−2,j−1)+P(i−2,j+1)+P(i+2,j−1)+P(i+2,j+1)). (3)

When the 5×5 kernel 242 is positioned at a blue pixel B, the horizontal edge strength component H(i,j) may be calculated using Equation 3.

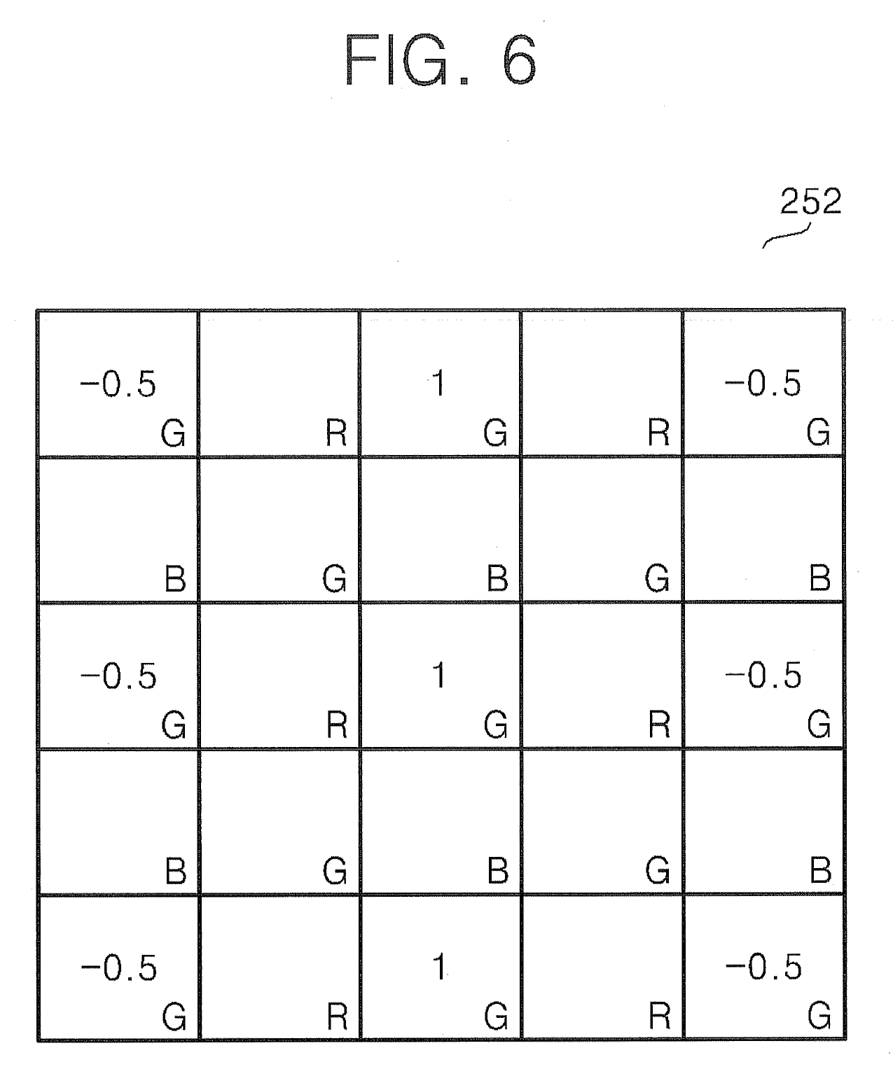

FIG. 6 shows weights used to calculate a vertical edge strength component V(i,j) when the 5×5 kernel 221 illustrated in FIG. 2 is positioned at a green pixel G. Referring to FIGS. 1 through 6, the pixels P(i−2,j−2), P(i−2,j+2), P(i,j−2), P(i,j+2), P(i+2,j−2), and P(i+2,j+2) have a weight of −0.5 and the pixels P(i−2,j), P(i,j), and P(i+2,j) have a weight of 1. When a 5×5 kernel 252 is positioned at a green pixel G, that is, when the pixel P(i,j) is a green pixel G, the vertical edge strength component V(i,j) is calculated using Equation 4:

V(i,j)=(P(i−2,j)+P(i,j)+P(i+2,j))−0.5*(P(i−2,j−2)+P(i,j−2)+P(i+2,j−2)+P(i−2,j+2)+P(i,j+2)+P(i+2,j+2)). (4)

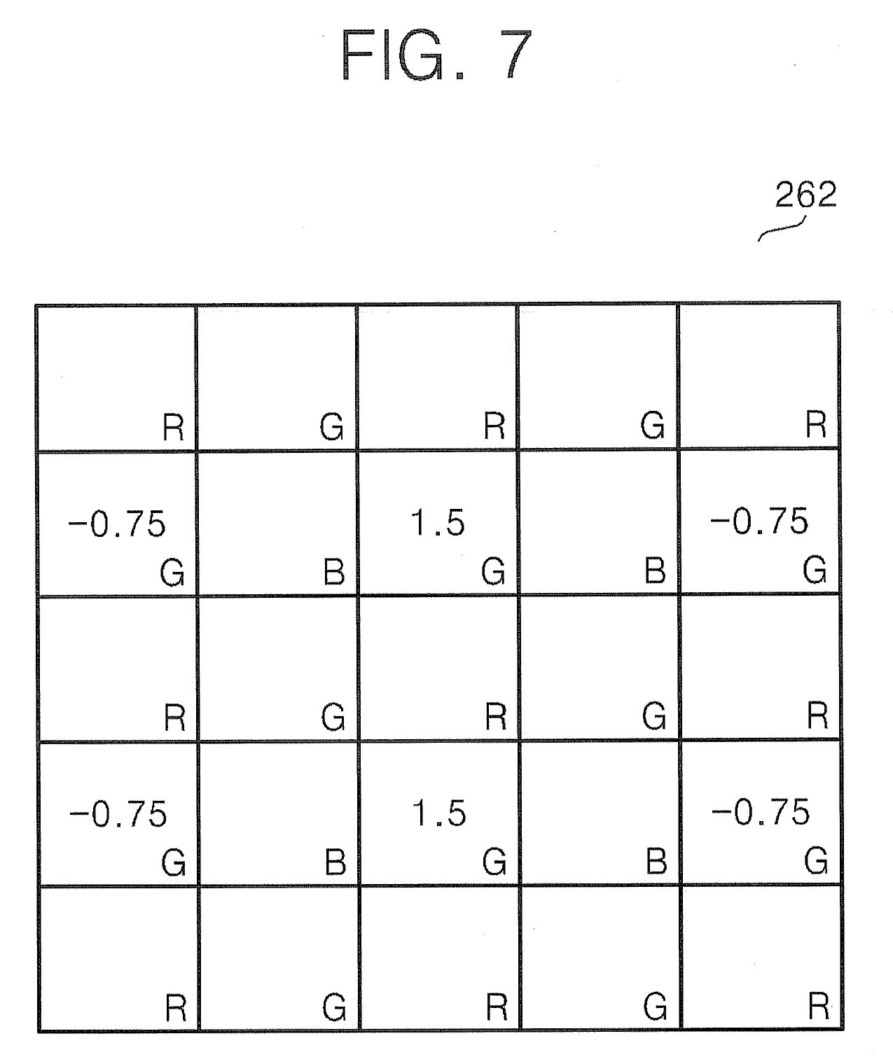

FIG. 7 shows weights used to calculate the vertical edge strength component V(i,j) when the 5×5 kernel 221 illustrated in FIG. 2 is positioned at a red pixel R. Referring to FIGS. 1 through 7, the pixels P(i−1,j−2), P(i−1,j+2), P(i+1,j−2), and P(i+1,j+2) have a weight of −0.75 and the pixels P(i−1,j) and P(i+1,j) have a weight of 1.5. When a 5×5 kernel 262 is positioned at a red pixel R, that is, when the pixel P(i,j) is a red pixel R, the vertical edge strength component V(i,j) is calculated using Equation 5:

V(i,j)=1.5*(P(i−1,j)+P(i+1,j))−0.75*(P(i−1,j−2)+P(i+1,j−2)+P(i−1,j+2)+P(i+1,j+2)). (5)

When the 5×5 kernel 262 is positioned at a blue pixel B, the vertical edge strength component V(i,j) may be calculated using Equation 5. The values of the weights may be changed. The edge direction T(i,j) may be expressed in terms of angle as shown in Equation 6:

D(i,j)=atan(T(i,j))*360/(2*Pi) (6)

where D(i,j) is a function expressed in terms of angle of the edge direction. Accordingly, T(i,j) and D(i,j) are functions expressing the value of the edge direction. Hereinafter, the edge direction is represented by D(i,j).

The edge direction D(i,j) may be efficiently calculated using a read-only memory (ROM) lookup table. The ROM lookup table may be provided by the PC I/F 230. The value of the edge direction D(i,j) has a range of 0 to 45 degrees.

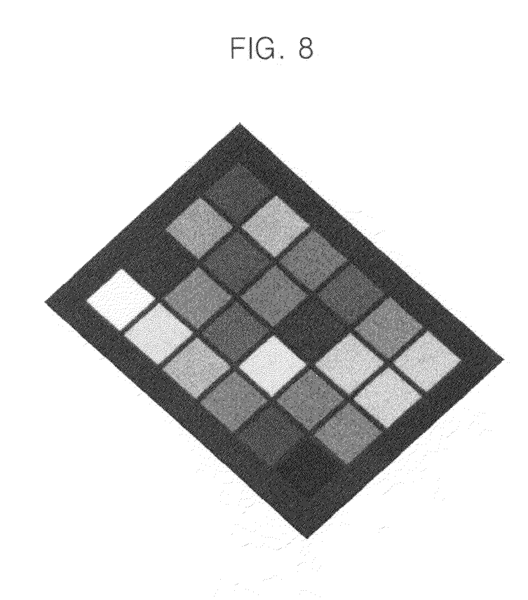

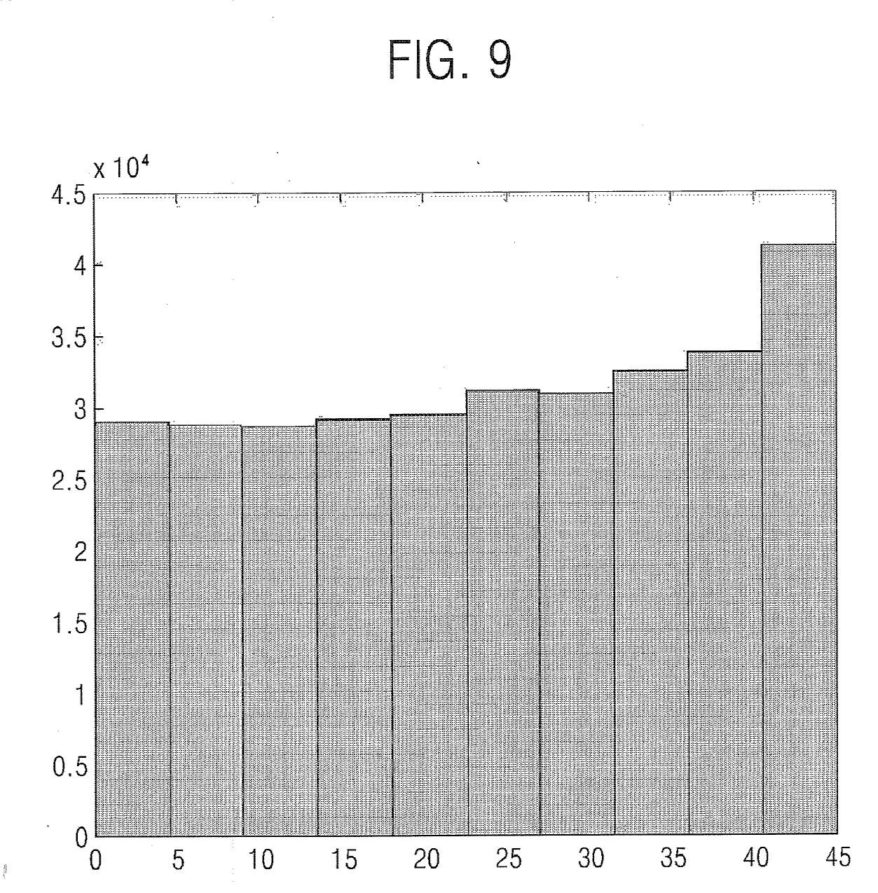

FIG. 8 shows a test chart image in which a predominant edge direction is 45 degrees. FIG. 9 is a histogram of the test charge image illustrated in FIG. 8. Referring to FIGS. 1 through 9, the histogram in FIG. 9 has 10 bins. However, the example embodiments are not limited to this number of bins. In the histogram, the x-axis indicates the angle of an edge direction and the y-axis indicates the number of pixels.

The image signal processor 220 may calculate the edge direction of each of the plurality of pixels P(i,j) by moving a 5×5 kernel on the image shown in FIG. 8. The image signal processor 220 creates the histogram by integrating the values of the edge directions of the respective pixels P(i,j). When any one of the values of the edge amplitudes of the respective pixels P(i,j) is less than a threshold value, an edge direction corresponding to the value of the edge amplitude less than the threshold value is excluded from the creation of the histogram.

When The absolute values of the horizontal and vertical edge strength components H(i,j) and V(i,j) of a pixel P(i,j) are 0, the edge direction of the pixel P(i,j) may be excluded from the creation of the histogram.

The image signal processor 220 sets a value of an edge direction occurring with the most frequency in the histogram as a predominant edge direction value Dp. The image signal processor 220 may set the value of the edge direction as the predominant edge direction value Dp only when the value of the edge direction exceeds the threshold value in the histogram. The predominant edge direction value Dp is calculated using Equation 7:

Dp=45*(Kp−1)/K (7)

where Kp indicates a bin including the greatest number of pixels and K indicates the total number of bins in the histogram.

Referring to FIG. 9, the bin including the greatest number of pixels in the histogram is the 10th bin, and therefore, Kp is 10. Since the total number of bins in the histogram is 10, K is 10. Accordingly, the predominant edge direction value Dp is 40.5. However, the value of the edge direction occurring with the most frequency in the histogram is 45 degrees. This is because the histogram has only 10 bins. When the histogram has more bins, the predominant edge direction value Dp can be more accurate.

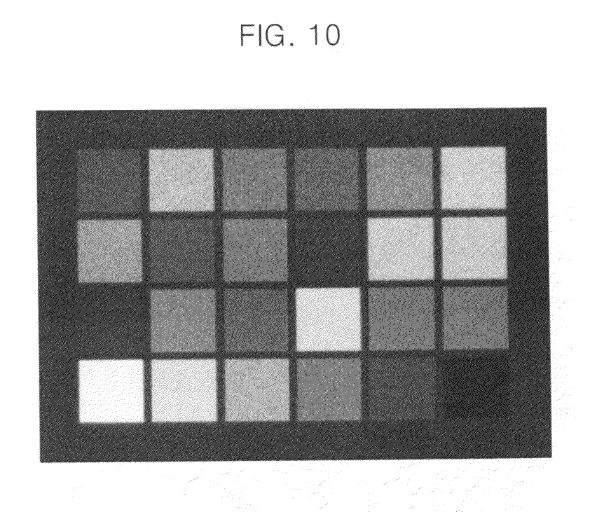

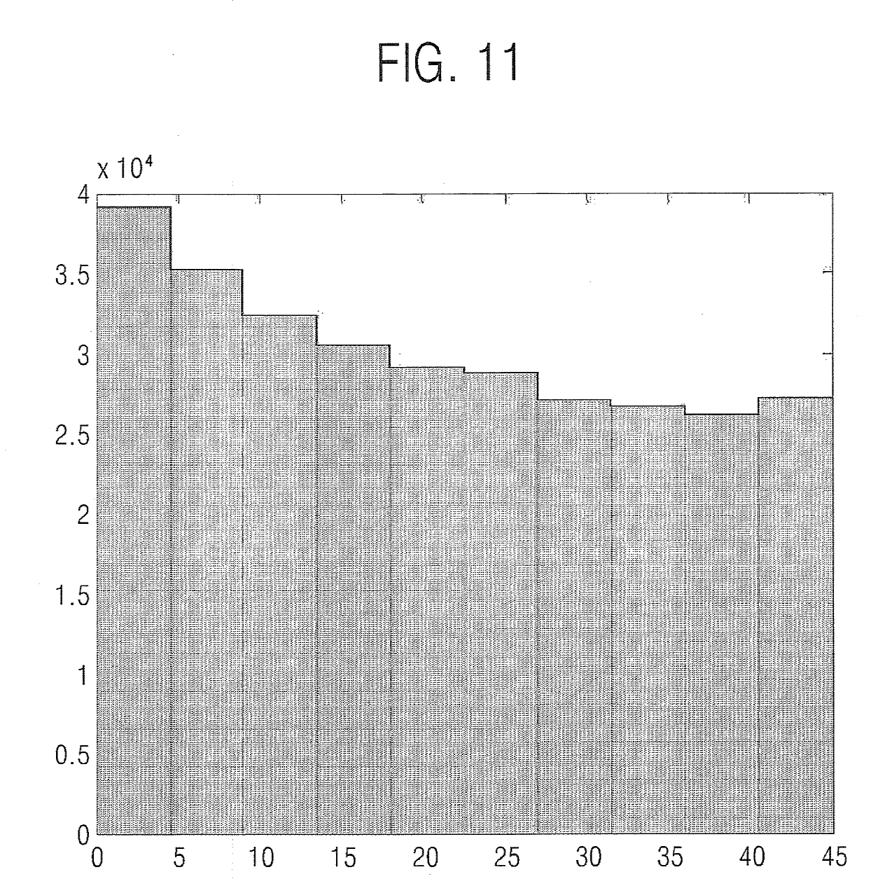

FIG. 10 shows a test chart image in which the predominant edge direction is horizontal. FIG. 11 is a histogram of the test charge image illustrated in FIG. 10. Referring to FIGS. 10 and 11, the bin including the greatest number of pixels in the histogram is the 1st bin, and therefore, Kp is 1. Accordingly, when the predominant edge direction value Dp is calculated using Equation 7, the predominant edge direction value Dp is 0. The predominant edge direction is vertical or horizontal. In addition, the 1st bin in the histogram includes about 3.9*10⁴ pixels, and therefore, the predominant edge direction value Dp is 0.

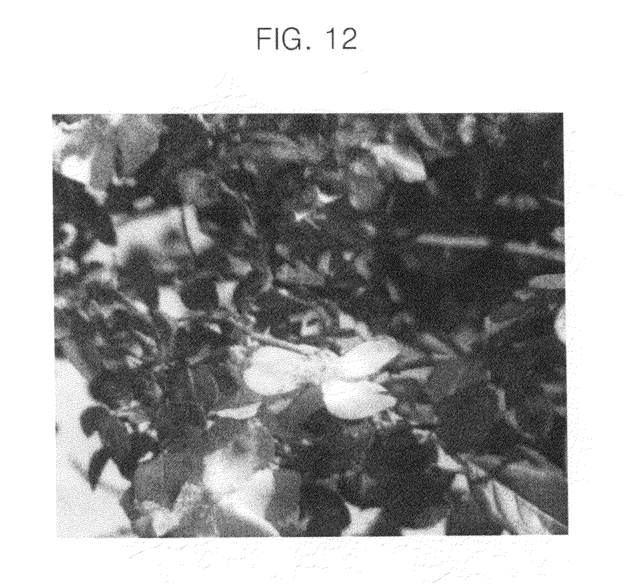

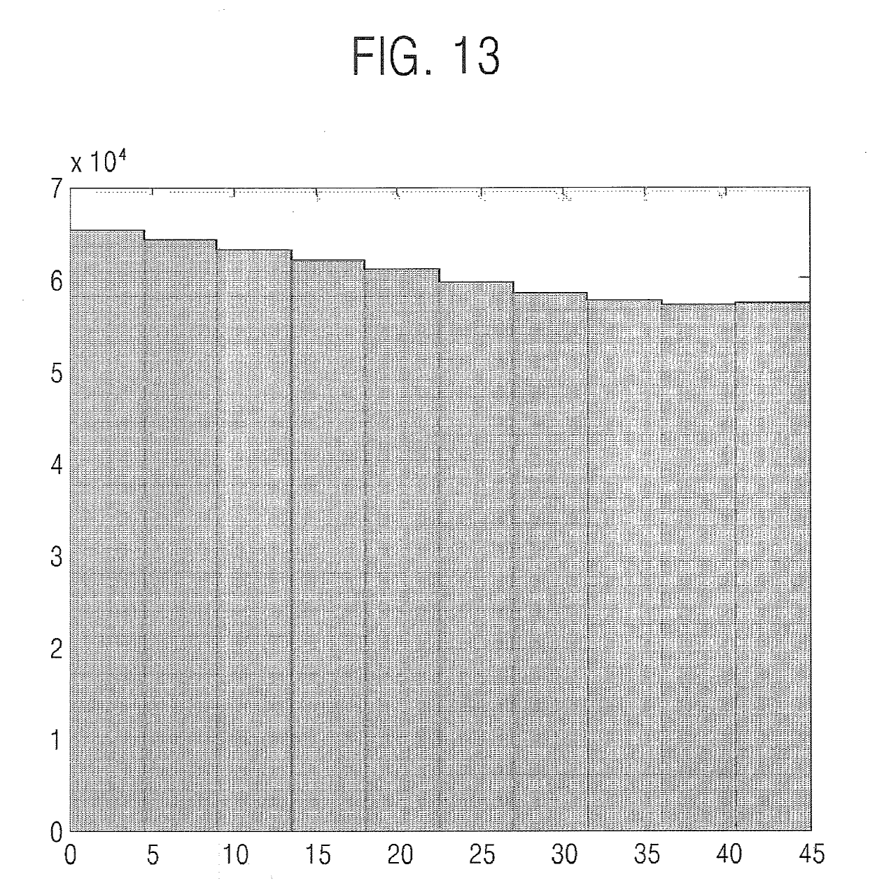

FIG. 12 shows a natural scene image. FIG. 13 is a histogram of the natural scene image illustrated in FIG. 12. Referring to FIGS. 12 and 13, since the edge direction occurring with the most frequency in the histogram corresponds to the 1st bin, Kp is 1. Accordingly, when the predominant edge direction value Dp is calculated using Equation 7, it is 0. The predominant edge direction is vertical or horizontal. In addition, the 1st bin includes about 6.5*10⁴ pixels in the histogram, and therefore, the predominant edge direction value Dp is 0.

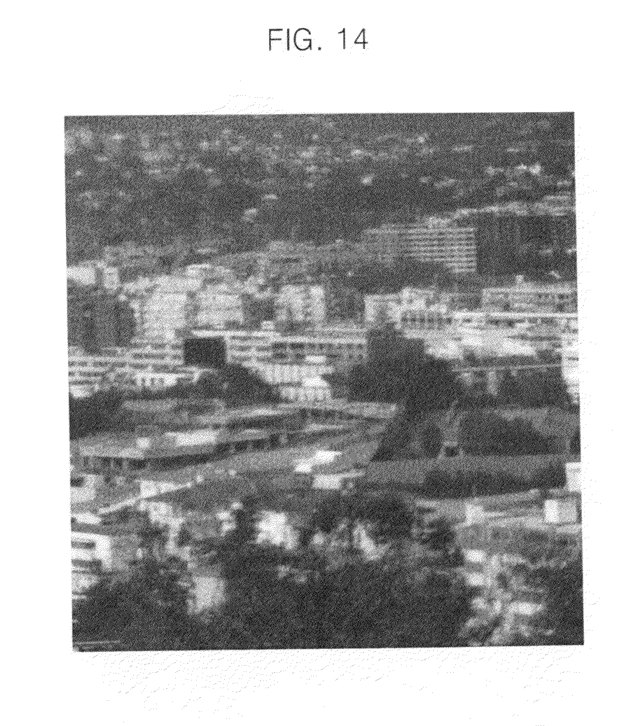

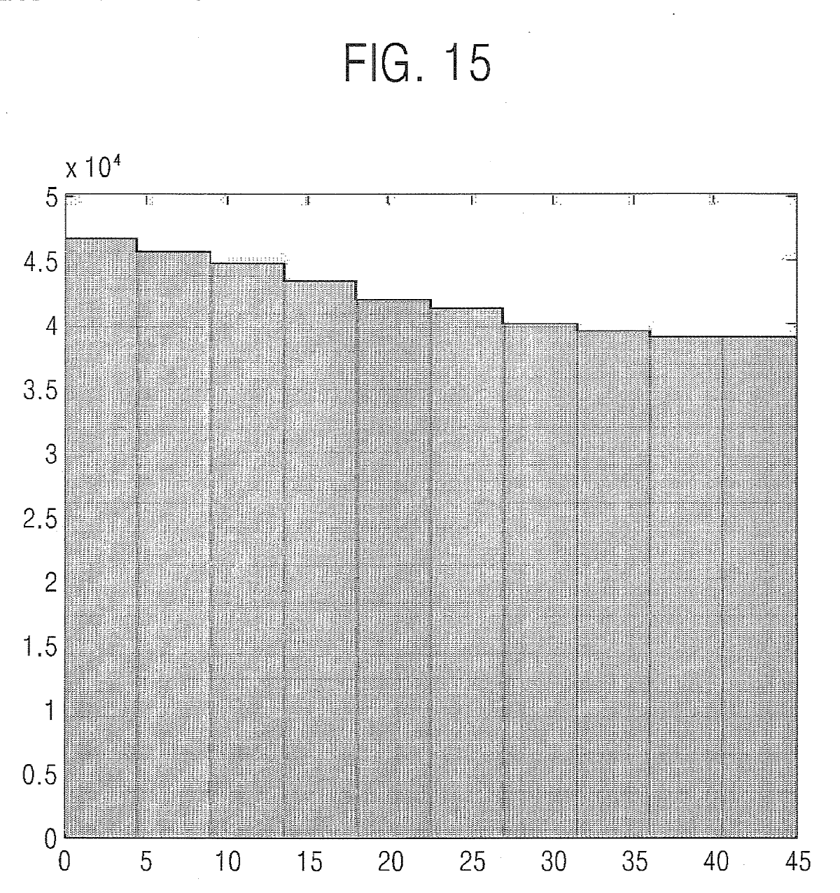

FIG. 14 shows an urban scene image. FIG. 15 is a histogram of the urban scene image illustrated in FIG. 14. Referring to FIGS. 14 and 15, since the edge direction occurring with the most frequency in the histogram corresponds to the 1st bin, Kp is 1. Accordingly, when the predominant edge direction value Dp is calculated using Equation 7, it is 0. The predominant edge direction is vertical or horizontal. In addition, the 1st bin includes about 4.6*10⁴ pixels in the histogram. Accordingly, the predominant edge direction is vertical or horizontal and the angle Dp of the predominant edge direction is 0 degrees.

When the predominant edge direction of an urban or indoor scene image is horizontal, it may simultaneously be vertical. At this time, the angle of the predominant edge direction may be expressed by (Dp+90). Alternatively, the histogram may include two or more predominant edge directions. At this time, the value of the edge direction may range from 0 to 90 degrees.

The image signal processor 220 generates a sharpening attenuation lookup table using the predominant edge direction Dp and the edge direction D(i,j) of each pixel. A sharpening attenuation function, i.e., S((D(i,j),Dp,a), is expressed by Equation 8:

S((D(i,j),Dp,α)=1/(1+|D(i,j)−Dp|*α) (8)

where “α” is a parameter controlling attenuation strength. The parameter a is an empirically determined design parameter.

The parameter a may be set to 0 to disable direct attenuation or may be set to a value greater than 0 to increase an attenuation effect. For instance, in one embodiment α may be 1/45.

The image signal processor 220 calculates the amount of sharpening using the sharpening attenuation lookup table. The amount of sharpening is calculated using Equation 9:

A(i,j)=max(|H(i,j)+V(i,j)|−A min,0)*Sgn(H(i,j)+V(i,j))*S((D(i,j),Dp,α) (9)

where A(i,j) is the amount of sharpening.

Sgn(H(i,j)+V(i,j)) is a function that is 1 when H(i,j)+V(i,j) is greater than 0, is −1 when H(i,j)+V(i,j) is less than 0, and is 0 otherwise.

“Amin” indicates a noise floor. When |H(i,j)+V(i,j)| is less than Amin, |H(i,j)+V(i,j)| is judged as noise not an image. Amin may be a constant.

Amin may be expressed as a function of pixel luminance because the noise floor is physically dependent on pixel brightness. The function Amin is expressed by Equation 10:

Amin(i,j)=(kr*R(i,j)+kg*G(i,j)+kb*B(i,j))*a+b (10)

where kr, kg, and kb are empirically determined design parameters, each of which is selected to calculate a luminance signal from an RGB image. For instance in one embodiment kr, kg, and kb are 0.3, 0.5, and 02, respectively.

“a” and “b” are factors selected to amplify only image features without amplifying noise in dark and bright areas of the image. These factors may be empirically determined.

R(i,j), G(i,j), and B(i,j) indicate pixel signals of red, green and blue pixels, respectively. The image signal processor 220 performs sharpening on each pixel using the amount of sharpening. The sharpening is calculated using Equations 11, 12, and 13:

Rs(i,j)=clip(R(i,j)+A(i,j)*S, 0, Rmax) (11)

Gs(i,j)=clip(G(i,j)+A(i,j)*S, 0, Gmax) (12)

Bs(i,j)=clip(B(i,j)+A(i,j)*S, 0, Bmax) (13)

where a function clip(V, Vmin, Vmax) restricts a signal V to between Vmin and Vmax. Rs(i,j), Gs(i,j), and Bs(i,j) respectively indicate pixel signals of the red, green and blue pixels after the sharpening. R(i,j), G(i,j), and B(i,j) respectively indicate the pixel signals of the red, green and blue pixels before the sharpening.

“S” indicates overall sharpening strength. S may be an empirically determined design parameter. For instance, S in one embodiment is 1. Rmax, Gmax, and Bmax respectively indicate maximum available pixel signals of the red, green and blue pixels in the image sensor 100. Alternatively, the sharpening may be calculated using Equations 14, 15, and 16:

Rs(i,j)=min(R(i,j)*(1+A(i,j)*S), Rmax), (14)

Gs(i,j)=min(G(i,j)*(1+A(i,j)*S), Gmax), (15)

Bs(i,j)=min(B(i,j)*(1+A(i,j)*S), Bmax), (16)

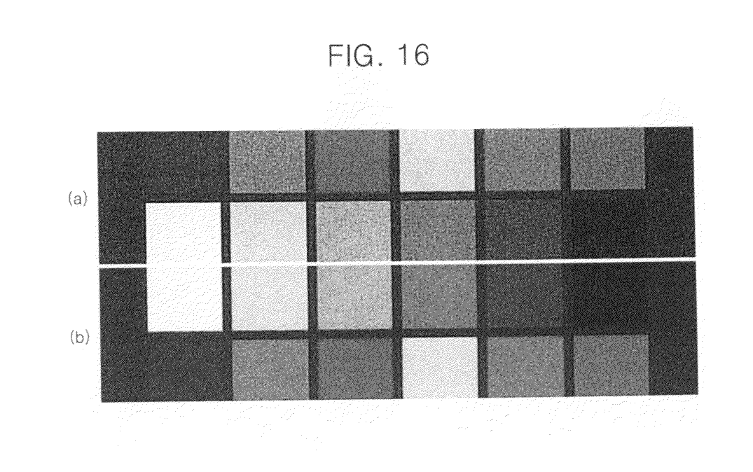

FIG. 16A shows a test chart image that has been sharpened using a conventional image sharpening method. FIG. 16B shows a test chart image that has been sharpened using an image sharpening method according to an example embodiment.

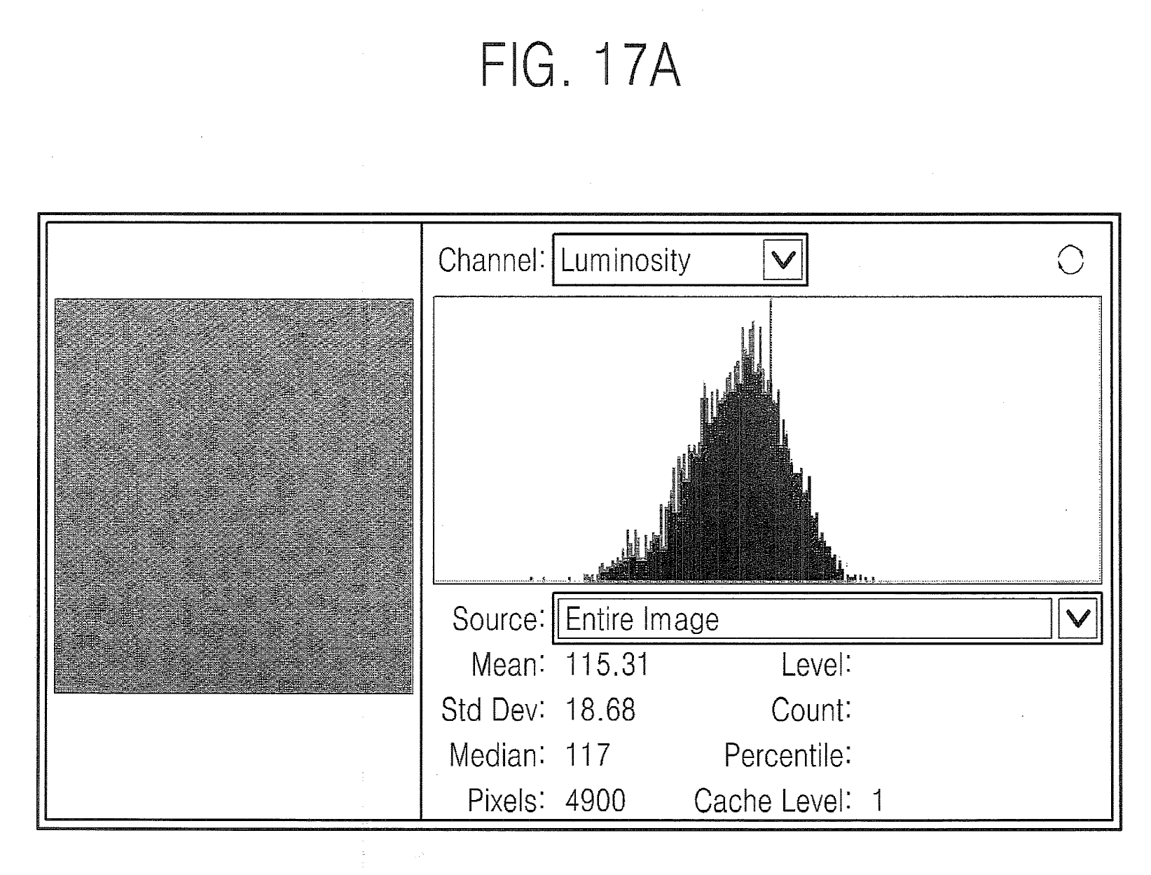

FIG. 17A is a graph showing the luminance noise of the image illustrated in FIG. 16A. FIG. 17B is a graph showing the luminance noise of the image illustrated in FIG. 16B. Referring to FIG. 17A, an image shown in FIG. 17A is a part of the image shown in FIG. 16A. The graph shown in FIG. 17A has a mean of 115.31 and a standard deviation Std Dev of 18.68, and therefore, a signal to noise ratio is 6.2 which is a result of dividing the mean by the standard deviation Std Dev. The signal to noise ratio may be expressed as 15.8 dB.

Referring to FIG. 17B, an image shown in FIG. 17B is a part of the image shown in FIG. 16B. The graph shown in FIG. 17B has a mean of 116.13 and a standard deviation Std Dev of 12.74, and therefore, a signal to noise ratio is 9.1 which is a result of dividing the mean by the standard deviation Std Dev. The signal to noise ratio may be expressed as 19.2 dB.

Accordingly, the image sharpening method according to an example embodiment improves an image 3.4 dB better than the conventional image sharpening method. In addition, the width of the graph shown in FIG. 17B is less than the width of the graph shown in FIG. 17A, which indicates that image values are less various. When the image values are more similar to one another, they are more desirable because the image values may be different from one another due to noise.

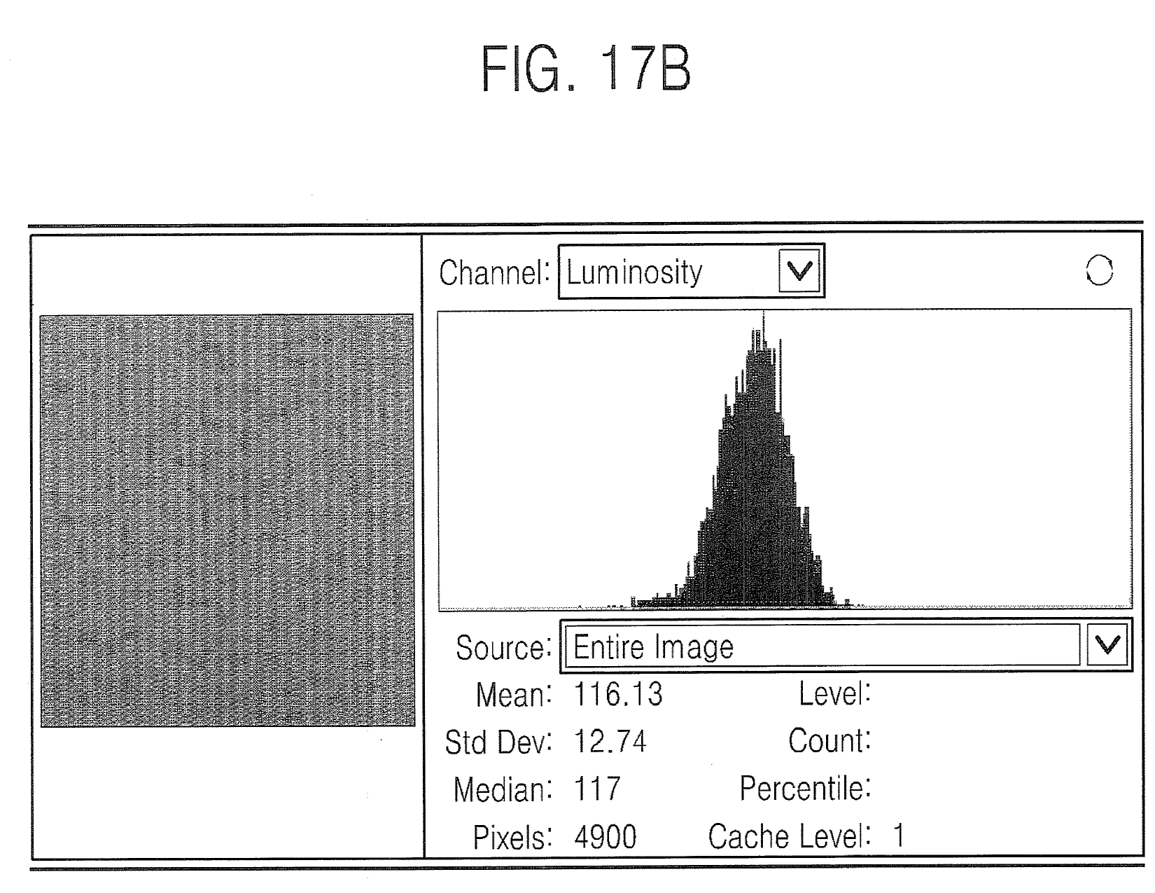

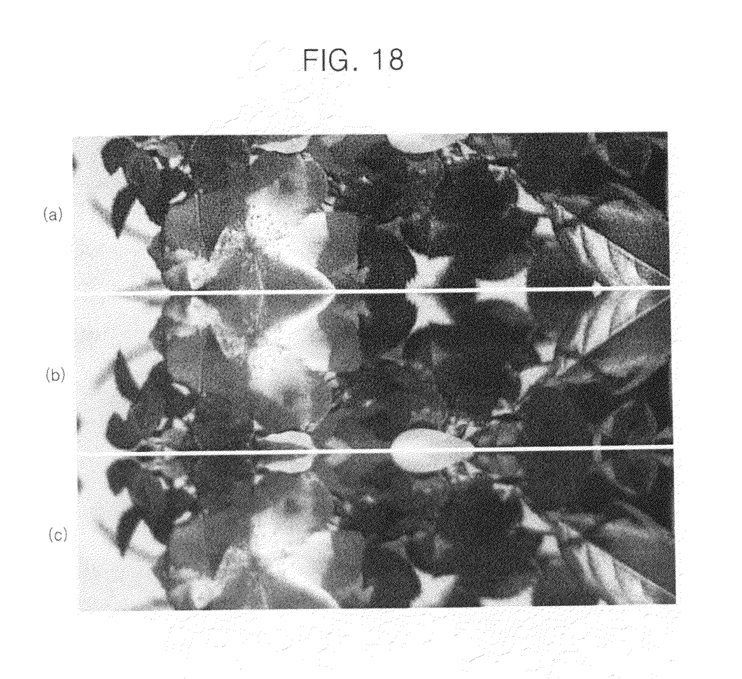

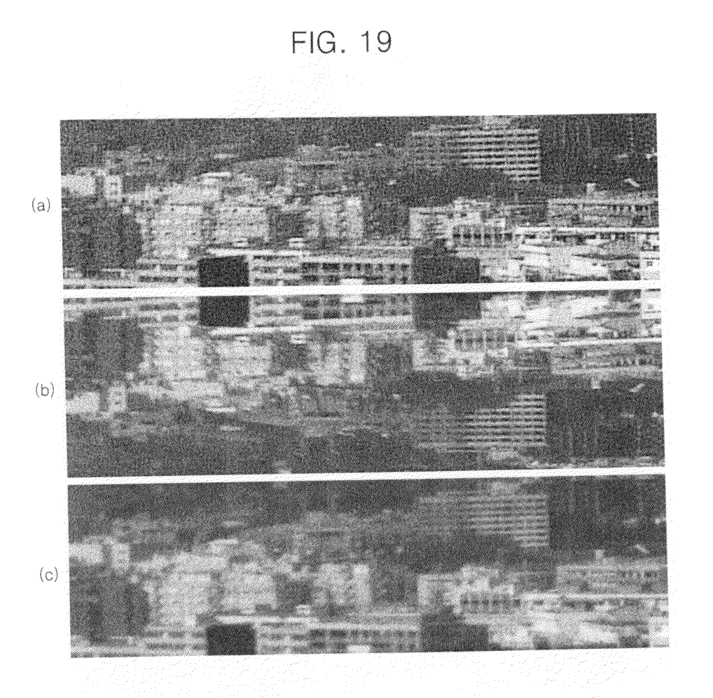

FIG. 18A shows a natural scene image that has been sharpened using the conventional image sharpening method. FIG. 18B shows a natural scene image that has been sharpened using the image sharpening method according to an example embodiment. FIG. 18C shows a natural scene image that has not been subjected to image sharpening. FIG. 19A shows an urban scene image that has been sharpened using the conventional image sharpening method. FIG. 19B shows an urban scene image that has been sharpened using the image sharpening method according to an example embodiment. FIG. 19C shows an urban scene image that has not been subjected to image sharpening.

The image sharpening method according to an example embodiment is more efficient with respect to scenes having a predominant edge direction. For instance, the scenes having the predominant edge direction are urban scenes, indoor scenes, and test, charts.

The image signal processor 220 is positioned within the DSP 200 in FIG. 1, but the design may be changed by those of ordinary skill in the art. For instance, the image signal processor 220 may be positioned within an image sensor. At this time, reference numeral 100 denotes an image sensing block and reference numerals 100 and 200 together denote the image sensor.

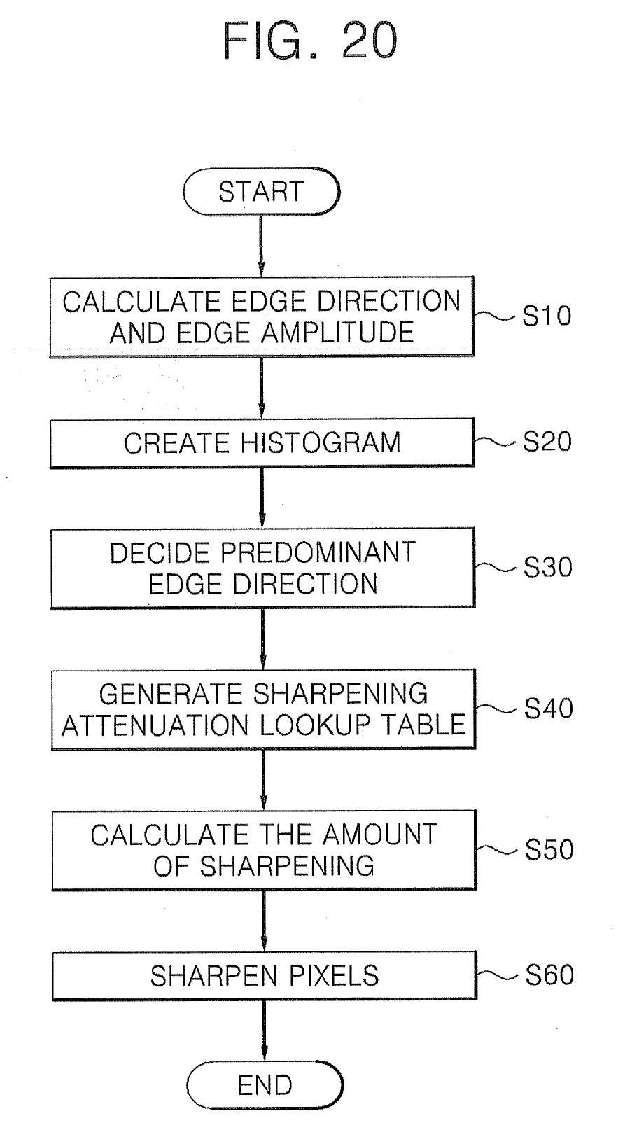

FIG. 20 is a flowchart of an image sharpening method for an image sensing system according to an example embodiment. Referring to FIGS. 1 through 20, the image signal processor 220 calculates the edge direction and the edge amplitude of each of a plurality of pixels in operation S10. The edge direction is calculated using the horizontal edge strength component H(i,j) and the vertical edge strength component V(i,j). The edge amplitude is calculated using the, difference between the first pixel signal P(i,j) and the second pixel signal P(i,j−1).

The image signal processor 220 creates a histogram by integrating the edge direction values D(i,j) of the respective pixels in operation S20. Among the edge directions of the respective pixels, an edge direction corresponding to an edge amplitude having a value less than a threshold value is excluded from the creation of the histogram. The image signal processor 220 sets an edge direction value D(i,j) occurring with the most frequency in the histogram as the value of the predominant edge direction Dp in operation S30.

The image signal processor 220 generates a sharpening attenuation lookup table using the predominant edge direction Dp and the edge directions of the respective pixels in operation S40. The image signal processor 220 calculates the amount of sharpening using the sharpening attenuation lookup table in operation S50. The image signal processor 220 sharpens each of the pixels using the amount of sharpening in operation S60 using equations (11)-(13) or (14)-(16).

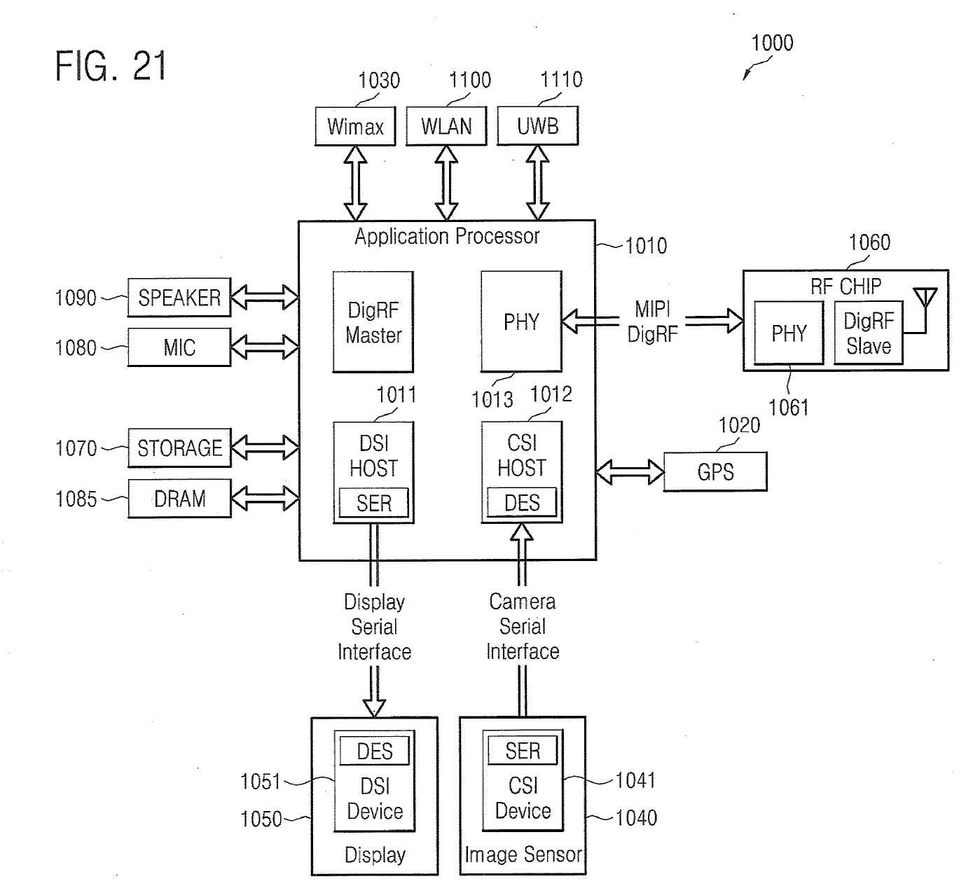

FIG. 21 is a schematic block diagram of an image sensing system 1000 according to an example embodiment. The image sensing system 1000 may be implemented as a data processing device, such as a mobile phone, a personal digital assistant (PDA), a portable media player (PMP), or a smart phone, which can use or support mobile industry processor interface (MIPI).

The image sensing system 1000 includes an application processor 1010, image sensor 1040, and a display 1050.

A camera serial interface (CSI) host 1012 implemented in the application processor 1010 may perform serial communication with a CSI device 1041 included in the image sensor 1040 through a CSI. At this time, an optical deserializer and an optical serializer may be implemented in the CSI host 1012 and the CSI device 1041, respectively.

The image sensor 1040 performs image sharpening according to at least one embodiment. Alternatively, the application processor 1010 may perform the image sharpening.

A display serial interface (DSI) host 1011 implemented in the application processor 1010 may perform serial communication with a DSI device 1051 included in the display 1050 through DSI. At this time, an optical serializer and an optical deserializer may be implemented in the DSI host 1011 and the DSI device 1051, respectively.

The image sensing system 1000 may also include a radio frequency (RF) chip 1060 communicating with the application processor 1010. A physical layer (PHY) 1013 of the application processor 1010 and a PHY 1061 of the RF chip 1060 may communicate data with each other according to MIPI DigRF.

The image sensing system 1000 may further include a global positioning system (GPS) 1020, a storage 1070, a microphone (MIC) 1080, a dynamic random access memory (DRAM) 1085, and a speaker 1090. The image sensing system 1000 may communicate using a Worldwide interoperability for microwave access (Wimax) 1030, a wireless local area network (WLAN) 1100, and an ultra-wideband (UWB) 1110.

According to some embodiments, image features are distinguished from noise and sharpening is applied to the image features only, so that noise is not increased while an image is sharpened.

While the embodiments have been particularly shown and described , it will be understood by those of ordinary skill in the art that various changes in forms and details may be made therein without departing from the spirit and scope of the inventive concepts as defined by the following claims.

1. A method for image sharpening, the method comprising:
deciding a predominant edge direction of an image based on edge directions of a plurality of pixels; and
sharpening each of the pixels based on the predominant edge direction and the edge directions of the pixels.

2. The method of claim 1, wherein the deciding the predominant edge direction of the image comprises:
calculating an edge direction and an edge amplitude of each of the pixels;
creating a histogram by integrating the edge directions of the pixels; and
setting an edge direction occurring with a greatest frequency in the histogram as the predominant edge direction.

3. The method of claim 2, wherein the calculating the edge direction and the edge amplitude of each of the pixels comprises:
calculating a horizontal edge strength component and a vertical edge strength component using a pixel signal of a selected one of the pixels and pixel signals of neighbor pixels neighboring the selected pixel;
calculating the edge direction using the horizontal edge strength component and the vertical edge strength component; and
calculating the edge amplitude using a difference between a pixel signal of the selected pixel and a pixel signal of one of the neighbor pixels.

4. The method of claim 2, wherein the edge direction has a value ranging from 0 to 45 degrees.

5. The method of claim 2, wherein the creating the histogram comprises excluding an edge direction corresponding to a value of an edge amplitude which is less than a threshold value.

6. The method of claim 1, wherein the sharpening each of the pixels comprises:
generating a sharpening attenuation lookup table using the predominant edge direction and the edge directions of the pixels;
calculating an amount of sharpening using the sharpening attenuation lookup table; and
sharpening each of the pixels using the amount of sharpening.

7. An image sensor comprising:
an image sensing block configured to convert an optical image into electrical image data and output the electrical image data; and
an image signal processor configured to decide a predominant edge direction of the electrical image data using edge directions of a plurality of pixels forming the electrical image data and to sharpen each of the pixels based on the predominant edge direction and the edge directions of the pixels.

8. The image sensor of claim 7, wherein the image signal processor is configured to calculate an edge direction and an edge amplitude of each of the pixels, create a histogram by integrating the edge directions of the pixels, and set an edge direction occurring with a greatest frequency in the histogram as the predominant edge direction.

9. The image sensor of claim 7, wherein the image signal processor is configured to calculate a horizontal edge strength component and a vertical edge strength component using a pixel signal of a selected one of the pixels and pixel signals of neighbor pixels neighboring the selected pixel, calculate the edge direction using the horizontal edge strength component and the vertical edge strength component, and calculate the edge amplitude using a difference between a pixel signal of the selected pixel and a pixel signal of one of the neighbor pixels.

10. The image sensor of claim 7, wherein the edge direction has a value ranging from 0 to 45 degrees.

11. The image sensor of claim 8, wherein, when a value of an edge amplitude of any one of the pixels is less than a threshold value, the image signal processor is configured to exclude an edge direction corresponding to the value of the edge amplitude from the histogram.

12. The image sensor of claim 7, wherein the image signal processor is configured to generate a sharpening attenuation lookup table using the predominant edge direction and the edge directions of the pixels, calculate an amount of sharpening using the sharpening attenuation lookup table, and sharpen each of the pixels using the amount of sharpening.

13. An image sensing system comprising:
an image sensor configured to convert an optical image into electrical image data and output the electrical image data; and
an image signal processor configured to decide a predominant edge direction of the electrical image data using edge directions of a plurality of pixels forming the electrical image data and to sharpen each of the pixels based on the predominant edge direction and the edge directions of the pixels.

14. The image sensing system of claim 13, wherein the image signal processor is configured to calculate an edge direction and an edge amplitude of each of the pixels, create a histogram by integrating the edge directions of the pixels, and set an edge direction occurring with a greatest frequency in the histogram as the predominant edge direction.

15. The image sensing system of claim 13, wherein the image signal processor is configured to calculate a horizontal edge strength component and a vertical edge strength component using a pixel signal of a selected one of the pixels and pixel signals of neighbor pixels neighboring the selected pixel, calculate the edge direction using the horizontal edge strength component and the vertical edge strength component, and calculate the edge amplitude using a difference between a pixel signal of the selected pixel and a pixel signal of one of the neighbor pixels.

16. The image sensing system of claim 14, wherein the edge direction has a value ranging from 0 to 45 degrees.

17. The image sensing system of claim 14, wherein, when a value of an edge amplitude of any one of the pixels is less than a threshold value, the image signal processor is configured to exclude an edge direction corresponding to the value of the edge amplitude from the histogram.

18. The image sensing system of claim 13, wherein the image signal processor is configured to generate a sharpening attenuation lookup table using the predominant edge direction and the edge directions of the pixels, calculate an amount of sharpening using the sharpening attenuation lookup table, and sharpen each of the pixels using the amount of sharpening.

19-24. (canceled)
